(19) United States
(12) Patent Application Publication
(10) Pub. No.: US 2002/0003702 A1
(43) Pub. Date: Jan. 10, 2002

(54) Lighting strip system and a method of mounting a lighting strip system

(76) Inventors: Gerald Ladstatter, Klaus (AT); Wolfgang Gadner, Horbranz (AT)

Correspondence Address: FITZPATRICK CELLA HARPER & SCINTO, 30 ROCKEFELLER PLAZA, NEW YORK, NY, 10112, US

(21) Appl. No.: 09/896,617

(22) Filed: Jul. 2, 2001

Related U.S. Application Data
(63) Continuation of application No. PCT/EP99/10397, filed on Dec. 27, 1999.

(30) Foreign Application Priority Data
Dec. 30, 1998 (DE) 298 23 255.3
Dec. 30, 1998 (DE) 298 23 256.1

(51) Int. Cl. F21V 21/00

(52) U.S. Cl. 362/249

(57) ABSTRACT

The invention relates to a lighting strip system, including a carrier rail (3), which bounds a hollow space, to be mounted on a wall or ceiling, a plurality of electrical wires (12) running longitudinally in the hollow space, for the delivery of supply voltage and, if applicable, control signals, a plurality of coupling parts (13a) arranged in the hollow space with spacing in the longitudinal direction of the carrier rail (3) and electrically connected with the wires (12), a plurality of elongate lights (A1, A2, A3 . . . ) which can be mounted one after another in the longitudinal direction of the carrier rail (3) on the carrier rail (3), and electrical counter-coupling parts (13b) provided on the lights (A1, A2, A3 . . . ) which when placed on the carrier rail (3) enter into the hollow space and make electrical plug contact with corresponding coupling parts (13a). In order to attain a simple and in particular rapid mounting, the coupling parts (13a) and the wires (12) constitute a prefabricated intermediate product, the carrier rail (3) being so formed that the intermediate product can be moved longitudinally into the carrier rail (3).

The invention relates to a lighting strip system and a method of mounting a lighting strip system in accordance with the preamble of claim 1, 7 or 16.

In, in particular, large rooms such as e.g. auditoria, halls or long corridors, it is usual, for the illumination of the room concerned, to install so-called track lights or lighting strips, which may consist of a plurality of lights or lighting bars arranged one after another in each case in a row, which can be mounted on the carrier concerned, e.g. a ceiling or wall of the room, directly or by means of a carrier rail.

In DE 196 15 597 A1 there is described a device of the kind indicated in the introduction for contacting the conductor wires of a through-wiring with the conductor wires of electrical connection conductors of the lights of a track light. This previously known lighting strip has a longitudinal channel, in particular rectangular, consisting of a carrier rail and a cover rail, through which the wires of the through-wiring extend. The carrier rail and the cover rail are releasably connected with one another by means of a quick-fastening connection. In the carrier rail there is arranged a plug-in sleeve connected by suitable means, e.g. a quick-fastening connection, with the base wall of the carrier rail. The plug-in sleeve consists of a base part which receives the wires in slots and a cover part arranged towards the cover rail which has plug-in sleeve holes in which there are arranged contact elements connected with the wires. The plug-in sleeve forms a first plug-in connection part associated with the carrier rail, which can be contacted with a second plug-in connection part having contact elements which is attached to the cover rail and the contact elements of which are connected with the lamp wiring. With this known configuration, the lamp is held in plug-in sockets, as is per se known, which stand up outwardly from the cover rail. With this known lighting strip it is possible to install the wiring from the open side of the carrier rail.

In DE 39 20 614 A1 there is described an attachment and connection system for the rapid mounting of lamps, in particular of lamps having a watertight housing. The main parts of this known attachment system are a holder, which can be attached to a ceiling or a cable guide by means of screws, whereby a two-part lamp housing is connected with the holder by means of a connecting device provided with hooks. Between the holder and the housing tub lying opposite thereto a through passage for cables is provided, which cables are longer than the holder and are mounted on a (non-illustrated) cable connection, which is arranged on the housing, for the electrical supply of the lights.

The object of the invention is so further develop a lighting strip system or a method of the kind indicated in the introduction that a simple and in particular rapidly effectable mounting of the wires or the through-wiring is possible.

This object is achieved by means of the features of claims 1 or 16. Advantageous further developing features of the invention are indicated in the subclaims.

The configurations in accordance with the invention according to claim 1 and the method in accordance with the invention according to claim 15, are based on the insight that the wires and the coupling parts can be longitudinally introduced into the profile or tube-like carrier rail as a prefabricated intermediate product. Thereby, the wires form connection or positioning elements which hold the coupling parts, pre-mounted at the predetermined spacings from one another, at these spacings. By these means there is ensured for all coupling parts in each case the position corresponding with the associated counter-coupling elements. In principle no longitudinal positioning of the through-wiring is needed since in the case of a horizontal arrangement of the carrier rail the longitudinal wiring remains in its movement end position. Upon connection of the coupling parts with the counter-coupling parts, upon placement of the lights, there is then effected automatically a form-fitting longitudinal positioning by means of the engagement of the counter-coupling elements. It is, however, advantageous to position the longitudinal wiring in its movement end position in the longitudinal direction of the carrier rail.

For a lighting strip system of the kind under consideration, particular requirements are also set for the sealing, in order to fulfil the requirements of a higher level of protection which corresponds for example to IP 65, with which the lighting strip system should be dustproof and protected against spray water.

Thus, the invention further has the object of improving the sealing with a lighting strip system of the kind under consideration.

This object is achieved by means of the features of claim 7. Advantageous further developments of the invention are indicated in the associated subclaims.

With the configuration in accordance with the invention a carrier rail according to claim 7 is provided, the side walls of which are connected with one another by means of a cover wall. The cover wall may be a continuous wall in which recesses are arranged in the region of the electrical plug-in connections for the lamps in each case dependent upon the length of the carrier rails, forming one or more through holes, through which the electrical connection is effected in each case by means of a plug. With the configuration in accordance with the invention the sealing of the carrier rail is largely improved by means of its cover wall, so that it needs apart therefrom a sealing or a covering solely in the region of the recesses and in the region of the joints between the carrier rail sections. By these means a significant improvement is already attained. The recesses themselves can be sealed or covered by means of covering or sealing the gaps between the counter-coupling elements and the recess edge. The joints in the region in the carrier rail sections can be sealed by means of seals.

The mounting of the wires with the at least one coupling part arranged prefabricated thereon is effected in that the wires are moved longitudinally into the hollow space of the carrier rail. This can be effected by means of pulling or pushing the wiring units. The latter is possible due to the stiffness of the wires. Thereby, the wires may have a particular length adapted to the length of a lighting strip section, or they may be drawn off from a longer supply reserve, e.g. rolled off a roll. The longitudinal spacing of the coupling parts connected with the wires is determined by means of the longitudinal spacing of the recesses in the cover wall of the carrier rail or by means of the length of the associated lights of the lighting strip. Preferably, the coupling parts are in each case formed as slides or arranged in a slide which is displaceable longitudinally through the carrier rail into a longitudinal position in which the coupling parts coincide with the associated recesses or associated counter-coupling parts of the lights. Thereby, the position of these plug-in connection parts in the transverse direction can be determined by means of a guide. In the longitudinal direction the position can be determined by means of a particular length of movement which, due to the knowledge of the position of the at least one recess, is predetermined. It is also possible to limit this length of movement by means of stop which, e.g. through the recess, can be inserted into the carrier rail and by means of abuting limits the movements of one or each coupling part. After the introduction of the so-called wiring the lights of the lighting strip can be mounted by lateral placement on the carrier rail, whereby plugs arranged on the lights are connected as counter-coupling parts with the coupling parts by means of plugging together. The coupling parts and the counter-coupling parts are preferably plug-coupling parts. In this connection position, the through-wiring with the coupling parts is arrested by means of the counter-coupling parts.

A further advantage of the configuration in accordance with the invention consists in that due to the presence of the cover wall of the carrier rail—closed except for the recesses—the sealing of the lighting strip is improved, in particular against dust and spray water.

Further, the wiring can be realised in a simple manner and with slight effort due to the axial introduction into the hollow space of the carrier rail, since the wiring needs only be pulled or pushed. With the known mounting measures, in contrast, the wiring must be mounted into the carrier rail by means of a lateral introduction movement, which in particular in the case of greater lengths of a lighting strip system is difficult and complicated.

Below, the invention and further advantages which can be achieved thereby will be described in more detail with reference to simplified drawings and advantageous configurations. There is shown:

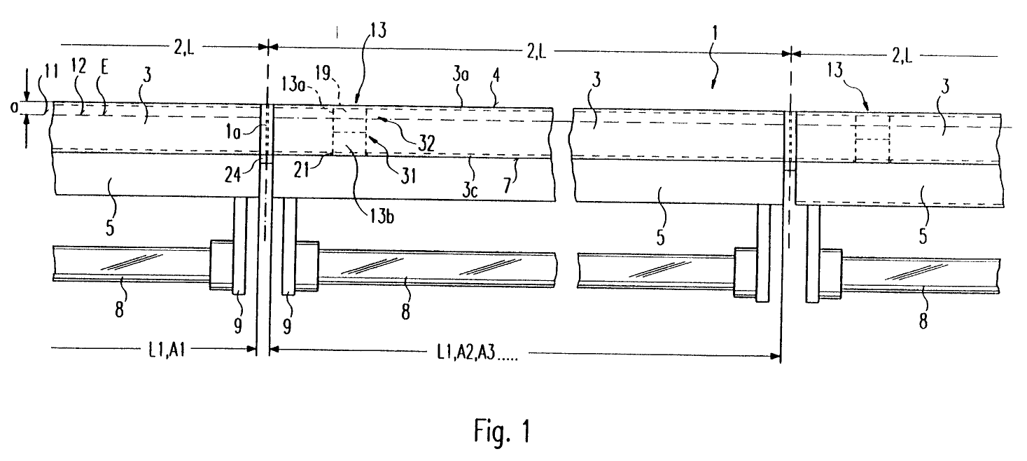

FIG. 1 a plurality of lighting strip sections in accordance with invention, of a lighting strip system, in a side view;

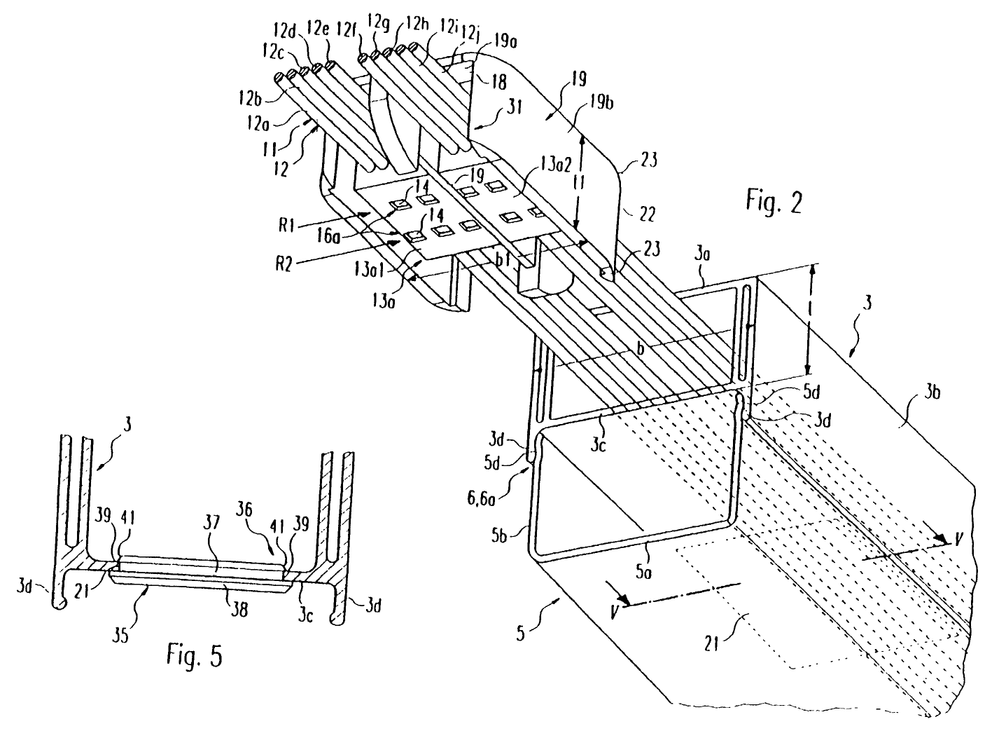

FIG. 2 a lighting strip section in accordance with a first exemplary embodiment, in a perspective cross-section;

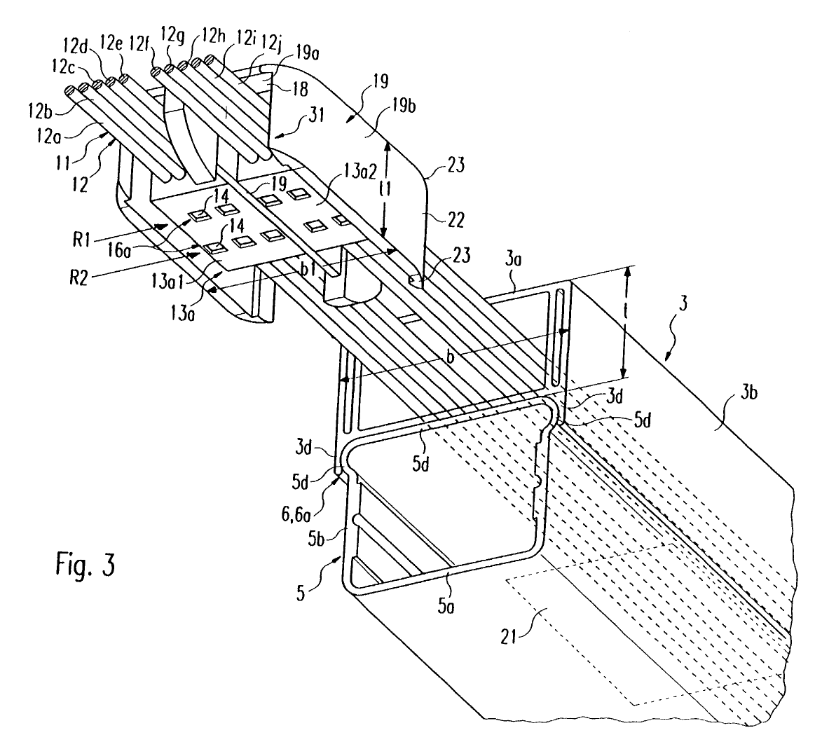

FIG. 3 a lighting strip section in accordance with a second exemplary embodiment, in a perspective cross-section;

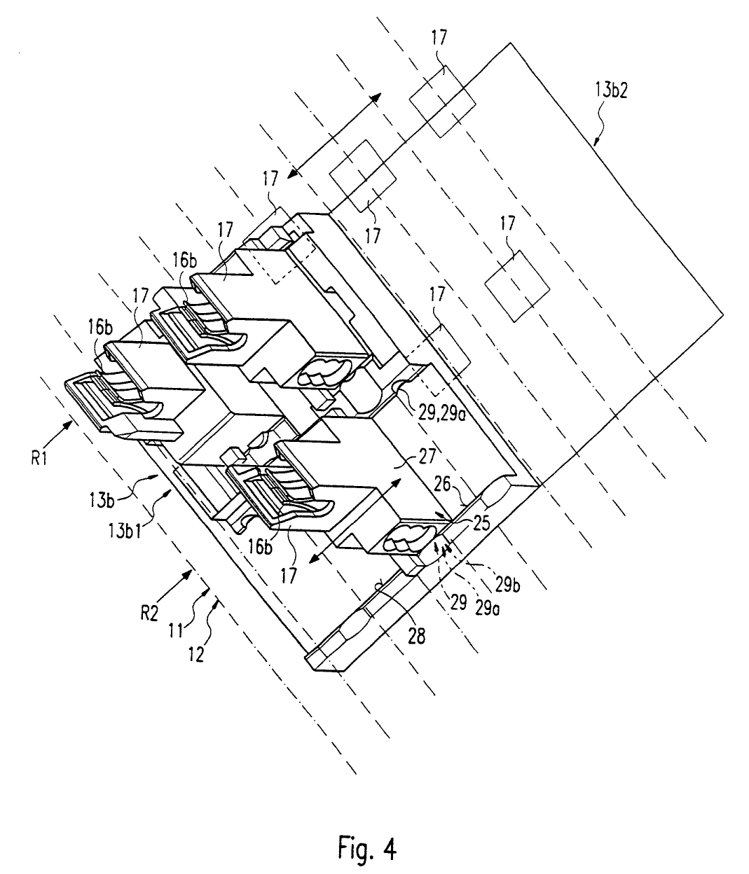

FIG. 4 a plug-in connection part in a perspective view from above;

FIG. 5 the partial section V-V of FIG. 2.

Of the lighting strip designated by 1 in FIG. 1 there is illustrated only a longitudinal section of the associated lighting strip system, which consists of a plurality of lighting strip sections 2 or modules arranged in a row one after another, the lengths L of which sections or modules are preferably the same but which in principle may differ, for example being determined by a transportable length of e.g. about 4 m to 6 m. The schematically illustrated joints of the lighting strip sections 2 are designated by 1a. Since the lighting strip sections 2 are identically formed, in the following only one lighting strip section 2 will be described.

The main parts of the lighting strip section 2 are a carrier rail 3, tube-like or U-shaped in cross-section, having a base side 4, shown in FIG. 1 to the top, with which the carrier rail 3 can be attached to a carrier (not shown), e.g. a room ceiling or a room wall, by means of non-illustrated first fastening means, e.g. screws, a plurality of substantially similar lights A1, A2, A3 . . . arranged one after another in the longitudinal direction of the lighting strip 1, in each case with a tub-shaped light body 5, which are each releasably connectable with the connection side 7 of the carrier rail 3, away from the base side 4, by means of non-illustrated second fastening means, e.g. a quick-fastening connection 6 or a latching device 6a, one or more lamps 8 arranged in parallel in, or with the present exemplary embodiment, on the light body 5, in this case gas discharge tubes, which are held by means of mountings on mounting bodies 9 on the light body 5 and by means of the length of which the length L1 of the light bodies 5 is determined, a through-wiring 11 having a plurality of wires 12, preferably nine or ten wires 12a to 12j, extending longitudinally through the carrier rail 3, which wires are arranged in a plane E extending parallel to the base wall 3a of the carrier rail at a spacing a from the base wall 3a and which may be formed by one so-called flat conductor ribbon, or two arranged next to one another, the individual wires of which ribbon or ribbons are held together by means of a ribbon extending longitudinally of the plane, a plurality of plug-in connections 13, each for a light A1, A2, A3 . . . , preferably arranged—seen transversely of the longitudinal direction—off-centre, and having a first plug-in connection part 13a preferably in the form of a socket which is arranged and positioned in the carrier rail 3, and at the end face towards the light body 5 having plug openings 14 of the same number as the wires 12 present, in which in each case a schematically illustrated contact element 16a can be arranged, which is located in a chamber, and a second plug-in connection part 13b corresponding thereto, preferably in the form of a plug, which is arranged on the light body 5 in apposition to the plug-in connection part 13a and has plug-in contact elements 16b each in apposition to the plug openings 14 arranged in one or two transverse rows R1, R2, which in each case can be contacted with a respective associated contact element 16a in the plug-in connection part 13a.

With the present configuration, the plug contact elements 16b are each located in a plug shaft 17 the cross-sectional shape and size of which is so adapted to the cross-sectional shape and size of the plug openings 14 that it can be plugged therein with slight play for movement and thus attains a guiding directed transversely to the longitudinal direction of the lighting strip 1.

The carrier rail 3 is a profile section, for example of plastics or aluminium, which can be manufactured by extrusion or, in the case of a U-shaped cross-section, can be manufactured by bending.

The number of light bodies 5 arranged one after another in the length region L of the lighting strip section 2 is determined by the length L1 of the light bodies 5, which is determined by means of conventional standardised dimensions of the elongate lamps 8 (gas discharge tubes). The mounting bodies 9 are arranged at the ends of the light bodies 5 whereby in each case they stand out from the light body 5 on the connection side away from the carrier rail 3. The lamps 8 may each be covered by means of a protective sleeve, which is not shown for reasons of simplification.

With the present configuration the first plug-in connection parts 13a are in each case formed by means of two plug-in connection parts 13a1, 13a2 in the shape of plug-in sleeves, arranged transversely next to one another, which form plug coupling parts and in each case are arranged and positioned in a chamber 18 of a slide 19, e.g. by means of non-illustrated latching devices. With the present configuration, the slide 19 has, in cross-section, a U-shape having a slide floor wall 19a towards the base side 4 and slide side walls 19b, extending in longitudinal direction, between which the one or both plug-in connection parts 13a1, 13a2 are arranged transversely adjacent one another and which may be separated from one another by means of middle wall 19c of the slide 19 running longitudinally. In a comparable manner the second plug-in connection part 13b associated with the respective light A1, A2, A3, can be formed by means of two plug-in connection parts 13b1, 13b2 or plugs, lying transversely adjacent one another.

The first plug-in connection parts 13a1, 13a2 having contact elements 16a and the associated second plug-in connection parts 13b1, 13b2 having counter-contact elements 16b in each case form plug-in coupling parts and plug-in counter-coupling parts for the direct or indirect electrical connection of the plug-in contact elements 16a, 16b with the associated wires 12a to 12j. Within the scope of the invention, the plug-in contact elements 16b may cooperate with the associated contact elements 16a belonging to the plug-in connection part 13a, or 13a1, 13a2, or the plug-in contact elements 16b may stand in direct contact with the associated wires 12a to 12j, whereby there may be involved the usual clamping contact elements or cutting/clamping contact elements, whereby the latter can cut into and contact insulated electrical wires 12. The mountings of the lamps 8 are in each case connected by means of conventional electrical conductors with the associated plug-in connection parts 13b1, 13b2.

The carrier rail 3 may have a U-shape in cross-section, whereby its side walls 3b form the limbs of the U-shape and its cover wall 3c forms the web wall of the U-shape, or it may have the shape of a preferably quadrilateral tube which is formed by means of the base wall 3a, the cover wall 3c and the side walls 3b. With the present configuration, the width b of the carrier rail 3 is greater than its depth t directed transversely to the plane E, whereby the side walls 3b form narrow sides and the cover wall 3c forms a broad side. In the cover wall 3c there is present, opposite to each first plug-in connection part 13a, a common plug recess 21 for the second plug-in connection part 13b or there is present a plurality of plug recesses (not shown) for the plug shafts 17. In both cases the second plug-in connection part 13b is contactable with the first plug-in connection part 3a, through the cover wall 3c and into the hollow space of the carrier rail 3.

The plug recess 21 or a plurality of above-described smaller plug recesses in the hole pattern of the plug shafts 17 can be worked e.g. by stamping the cover wall 3c at the particular locations concerned, at which a plug-in connection part 13b is in each case arranged. The arrangement position is indicated by means of the position of the plug-in connection part 13b on the light body 5.

The width b1 and the depth t1 of the slide 19 are so adapted to the associated internal dimensions of the carrier rail 3 that the slide 19 is longitudinally displaceable in the carrier rail 3 with slight play for movement, whereby the carrier rail 3 forms a guide for the slide 19. In order to facilitate jamming and the introduction of the slide 19 into the carrier rail 13 the end face edges of the slide 19 are interrupted by means of edge breaks 22, 23 or oblique surfaces or roundings.

The light body 5 may be box-like and U-shaped in cross-section, as is shown in FIG. 2, or tube-like as is shown in FIG. 3. In both cases the light body 5 has a base wall 5a and side walls 5b extending therefrom, which in the case of a tube-shape are connected with one another by means of a cover wall 5c, whereas in the case of a U-shape they are free web walls.

The quick-fastening connection 6 is preferably a latching device 6a the latching effect of which can be manually overcome so that the light body 5 can be pressed into the latching device 6a, with a certain mounting or dis-mounting force which is larger than a latching force, and for the purpose of release can be again taken out. The latching device 6a may be formed by means of latching webs 3d on the carrier rail 3, projecting from the side walls 3b and in particular running longitudinally continuously, which latching webs in the latching position engage behind latching edges 5d on the side walls 5b which develop preferably continuously in the longitudinal direction, whereby they are elastically bendable to the side by means of the exercise of a certain manual pressing or pulling force and thus can be overcome. The introduction of the light body 5 into the latching device 6a can be simplified by means of oblique surfaces or roundings on the side walls 5b and/or on the latching webs 3d. With the configuration according to FIG. 2, with which the light body 5 is U-shaped, the latching webs 3d may also be elastically yielding upon pressing in and thus may be overcome.

The plug-in connection part 13b is preferably a component associated with the light body 5, which is mounted onto this, so that the light body 5 with the plug-in connection part 13b is moveable against the carrier rail 3 and into the recess 21, whereby the plug-in connection part 13b contacts with the plug-in connection part 13a and the quick-fastening connection 6 comes to function and releasably secures the light body 5 to the carrier rail 3. The plug-in connection part 13b is arranged on the light body 5 preferably off-centre in its longitudinal direction, in particular in its end region.

Since with a lighting strip 1 of a lighting strip system a plurality of lights or light bodies 5 are present it is advantageous, for the purpose of avoiding an overloading, to provide a plurality of phase conductors in the through-wiring 11, e.g. three phase conductors, here the wires 12a, 12c, 12e and/or 12f, 12h, 12j, to which the lights are to be connected in distributed number. For this purpose there is associated with plug-in connection part 13a (not shown) or the plug-in connection part 13b a phase selection device 25 which in the case of the present configuration is formed by means of a displacement guide 26 for at least one contact element holder for a plug shaft 17, whereby the displacement guide 26 is displaceable advantageously at right angles to the lighting strip 1 selectively into the position of one phase conductor and is releasably arrestable in this displaced position. For this purpose the at least one plug shaft is formed as a slide 27 which is manually displaceable in the displacement device 26 on the body of the plug-in connection part 13b. The displacement guide is formed by a guide groove 28, in particular an undercut guide groove, extending transversely to the lighting strip 1, in which guide groove the at least one holder or plug shaft 17 is displaceably guided, the slider 27 of which is adapted to the cross-sectional form of the guide groove 28. For arresting in the desired displacement position, namely in the contact position with the desired phase conductor, there is provided in each case a clamping or latching device 29, which can be overcome, having a latching recess 29a and a latching nose 29b which engages into this, which with the present exemplary embodiment is arranged on the slider 27, or vice versa.

As can be understood from FIGS. 2 and 3, the plug openings 14 in the plug-in connection parts 13a and the plugs or plug shafts 17 on the plug-in connection parts 13b are arranged in at least two rows R1, R2 for reasons of exploiting the space available. With a phase selection device it is thereby advantageous that in the rows R1 and R2 in each case two non-displaceable plug shafts 17 follow a displaceable plug shaft 17 which can be displaced over at least three neighbouring wires 12. Such an arrangement can be realised in a simple manner, when plug-in connection parts are arranged next to one another, in that one plug-in connection part is arranged rotated by 180° with the regard to the other. This applies both for the plug-in connection parts 13a1, 13a2 and also for the plug-in connection parts 13b1, 13b2.

The above-described configuration of the lighting strip 1 improves on protection standard IP 65 so that the lighting strip 1 is dust-proof and protected against spray water. This protective standard is improved upon by means of the above-described configuration of the carrier rail 3, having apart from the plug recess 21 for the plug connection part 13b through the cover wall 3c—a continuously closed carrier rail 3 and also by means of the longitudinally continuous latching elements, namely the latching webs 3d, which bear throughout on the side walls 5b. In the abutment region of the carrier rail 3 and of the light body 5, the protective standard is ensured by means of seals 24.

The mounting of the lighting strip sections 2 can be effected at the place of manufacture or at the site of installation. The carrier rails 3, the light body 5 and the through-wiring 12 with the plug-in connection parts 13a are in each case pre-fabricated to this extent and made available as an intermediate product, for example on a roll. The through-wiring 11 can thereby in each case be adapted to the length L of the light strip section 2, if applicable with an excess in the joint region as necessary for the electrical connection, or may form a long supply reserve. Significant is that the spacings of the plug-in connection parts 13a with slides 19 pre-fabricated on the through-wiring 11 correspond to the spacings of the recesses 21 from one another which correspond to the lengths L, but are axially offset with regard to the joints 1a.

The mounting of the through-wiring 11, which is prefabricated with the one or more plug-in connection parts 13b, is effected in that it is introduced longitudinally into the carrier rail 3, which may be effected by means of pushing and/or pulling by means of a pulling cable or a pull or push rod or the like, and may be effected by means of an associated pushing or pulling device. The push rod or the pull cable can be longitudinally passed through the carrier rail 3, before pulling, and releasably connected with the associated end region of the wiring 12. Pulling in, the longitudinal wiring 11 is introduced so far into the carrier rail 3 that the plug-in connection part or parts 13a, or slide or slides 19. Thereby the longitudinal wiring 11 is introduced so far into the carrier rail that the plug-in connection part or parts 13a, or slide or slides 19, are located in the longitudinal position of the recesses 21. This position can be defined by means of a movement stop (not illustrated), which for example projects through the associated recess 21 into the path of movement of the slide 19. This fixing can be effected by means of stops placed into the recesses or for example frames which function as stops and which co-operate with counter-stops on the apposing plug-in connection part or slides. Thereby the thus formed arresting parts may also engage into holes in the plug-in connection parts or slides. Further, such an arresting can be effected by means of screws (not shown) penetrating through the cover wall 3c of the carrier rail 3 and engaging into the plug-in connection parts 13a or slides 19. In the transverse direction, the plug-in connection part 13a is positioned in the carrier rail 3 by means of their walls, which form a transverse positioning device 31. After the introduction, the longitudinal positioning can be effected by means of the available plug-in connection part or parts 13b, which by means of the form-fitting engagement into the associated plug-in connection part 13a form a longitudinal positioning device 32. A transverse positioning device for the slide 19 is, as described above, already provided by the internal dimensions of the carrier rail 3.

A dismounting of the through-wiring 11 with the plug-in connection part or parts 13a is effected in a reverse manner by means of longitudinally directed pulling out from the carrier rail 3, which can be effected manually or with the pull cable or push rod by means of an associated pulling device.

It is advantageous to so form the plug-in contact parts with a selection device 25 such that if necessary a coincidence can be brought about. With the present configuration, with which the contact positions are arranged in two rows R1, R2, the selection device 25 may be provided in the one or in the other row R1, R2 or in both rows R1, R2.

With all above-described exemplary embodiments it is advantageous, for the purpose of additional improvement of the covering or sealing of the hollow space of the carrier rail 3, to cover over or to seal with a closure part the recesses 21 which are not occupied with a plug-in connection part 13b, 13b1, 13b2. For this purpose there can serve in each case a closure plate 35 for example in the configuration and arrangement in accordance with FIG. 14, which covers or seals the associated recess 21. With the exemplary embodiment according to FIG. 14, the closure plate 35 is releasably connected to the cover wall 3c, preferably by means of a latching device 36. The closure plate 35 may have an insertion part 37 on one broad side which is insertable into the recess 21 and which for example clamps therein or preferably is latchable therein with the latching device 26. Thereby, the closure plate 35 may have a flange 38 which engages over the outer—with reference to the hollow space—recess edge of the recess 21 and thereby not only secures the position of the closure plate 35 but can also act in a covering and sealing manner. The latching device 36 may have a plurality of latching noses arranged distributed around the periphery, or a continuous latching edge 39, which in each case engage behind the inner edge of the recess 21. This engagement behind need only be slight. Due to the material elasticity present at least in the region of the latching edge 39, the closure plate 35 can be pressed and latched into the recess 21 by means of rounded or chamfered introduction surfaces 41, and can drawn out of the recess 21 by means of a pressing out, for example with the aid of a screw driver engaging beneath the flange 38, with a slight application of force. The closure plate 35 is preferably of plastics having an elasticity as described above.

1. Lighting strip system comprising:
a carrier rail which bounds a hollow space, said carrier rail being mountable on a wall or ceiling,
a plurality of electrical wires running longitudinally in said hollow space;
a plurality of coupling parts arranged in the hollow space and spaced apart from each other in a longitudinal direction of said carrier rail, said coupling parts being electrically connected with said electrical wires;
a plurality of elongate lights mounted one after another in said longitudinal direction on said carrier rail;
said carrier rail being formed with a wall which bounds said recesses in the wall with respect to said lights, said wall being formed with a recess;
electrical counter-coupling parts on said lights, said counter-coupling parts extending through the recesses and into the hollow space where they make electrical plug contact with corresponding ones of said coupling parts;
said coupling parts each being slidable longitudinally within said carrier rail;
said coupling parts and said wires forming a prefabricated intermediate product; and
said carrier rail having internal dimensions which permit close longitudinal guidance for longitudinal movement therein of said coupling parts.

2. Lighting strip system according to claim 1, wherein:
at least one of said coupling parts and counter-coupling parts comprises two coupling members arranged transversely next to one another for longitudinal movement on a common slide within said hollow space.

3. Lighting strip system according to claim 2 or claim 13, wherein:
said wires extend next to each other in a common plane and wherein one coupling part is rotated by 180° relative to a corresponding counter-coupling part, said coupling and counter-coupling parts extending parallel to said common plane.

4. Lighting strip system according to claim 1 or claim 13, further including:
a transverse positioning device configured to position said coupling parts transversely relative to the carrier rail.

5. Lighting strip system according to claim 1 or claim 13, further including:
a stop arranged to limit movement of coupling part into disposition with a corresponding counter-coupling part.

6. Lighting strip system according to claim 1 or claim 13, wherein:
the coupling parts are configured to be fixed on the carrier rail.

7. Lighting strip system according to claim 1 or claim 13, further including:
a frame mounted over at least one of said recesses in said carrier rail and an arresting means located on said frame for arresting movement of an associated coupling part.

8. Lighting strip system according to claim 1 or claim 13, wherein:
a light body having a U-shaped or a tube-like cross-sectional form is provided for each of said lights.

9. Lighting strip system according to claim 1 or claim 13, wherein
a releasable connector is provided for connecting said lights with said carrier rail.

10. Lighting strip system according to claim 1 or claim 13, further including:
a contact position selector device is arranged in association with the coupling parts or said counter-coupling parts.

11. Lighting strip system according to claim 1 or claim 13, wherein:
said coupling parts and said counter-coupling parts have contact elements in two transversely running rows, and wherein said selection device is associated with at least one of said rows.

12. Lighting strip system according to claim 1 or claim 13, wherein:
recesses which are not occupied by counter-coupling parts or occupied recesses are closed by means of a closure element.

13. Lighting strip system according to claim 1, wherein:
at least one slide, which forms part of said prefabricated intermediate product, is provided in said hollow space in said carrier rail, said slide having cross-sectional dimensions that are so adapted to the associated internal dimensions of the carrier rail that the slide is longitudinally displaceable in the carrier rail with a slight play for movement whereby said carrier rail forms a longitudinal guide for the slide, and wherein;
said coupling part is mounted in said slide.
